(19) United States
(12) Patent Application Publication
(10) Pub. No.: US 2017/0073237 A1
(43) Pub. Date: Mar. 16, 2017

(54) METHOD FOR MANUFACTURING HOLLOW SILICA PARTICLES, HOLLOW SILICA PARTICLES, AND COMPOSITION AND THERMAL INSULATION SHEET COMPRISING SAME

(71) Applicant: SUKGYUNG AT CO., LTD., Ansan-si (KR)

(72) Inventors: Hyung Sup LIM, Ansan-si (KR); Young Cheol YOO, Ansan-si (KR); O Sung KWON, Gunpo-si (KR); Eun Young SONG, Incheon (KR)

(73) Assignee: SUKGYUNG AT CO., LTD ., Ansan-si (KR)

(21) Appl. No.: 15/035,355

(22) PCT Filed: Apr. 23, 2015
(86) PCT No.: PCT/KR2015/004057

§ 371 Date: May 9, 2016

(30) Foreign Application Priority Data
May 30, 2014 (KR) 10-2014-0065775
Apr. 21, 2015 (KR) 10-2015-0055981

(51) Int. Cl. C01B 33/18; C08K 7/26; E06B 9/24; C08J 7/04; C09D 179/08; E06B 3/00; C09D 7/12; C08K 3/36

(52) U.S. Cl. CPC C01B 33/18; C09D 7/1291; C09D 7/1283; C08K 7/26; C08K 3/36; C08J 7/047; C09D 179/08; E06B 3/00; E06B 9/24; C01P 2004/34; C01P 2006/32; C01P 2006/19; C01P 2004/61; C08K 2201/003; C08J 2367/02; C08J 2479/08; E06B 2009/2417

(57) ABSTRACT

Provided are hollow silica particles that have a refractive index of 1.2-1.4, a thermal conductivity of less than 0.1 W/m·K, an oil absorption rate of 0.1 ml/g or below, a porosity of at least 90% when mixed with a resin, and a particle distribution coefficient of variation (CV value) of 10% or below. Further provided are a composition comprising the hollow silica particles, and a transparent thermal insulation sheet which has a visible light transmittance of at least 70%, a thermal conductivity of less than 0.1 W/m·K, and a filling rate of particles of 30-80%.

### TECHNICAL FIELD

The present invention disclosed herein relates to hollow silica particles having complex properties and a method of manufacturing the same, and a composition and a thermal insulation sheet which include the hollow silica particles.

### BACKGROUND ART

The cost of heating and cooling buildings is approximately 25 trillion won or more annually. Recently, the use of glass as an exterior decoration material is being increased and, among heating and cooling energy, the rate of heat loss through windows accounts for the largest share with 39% of total heat loss. Thus, measures to reduce the increasing heating and cooling energy consumption are urgent and, in addition, there emerges a need to improve window insulation performance. In recent years, there is a need to develop a thermal insulation material for manufacturing a heat insulation sheet, which satisfies two characteristics of transparency and thermal insulation, and to develop an eco-friendly new material. Hollow silica particles may be used as one of such thermal insulation materials, wherein KR 101180040 discloses a method of manufacturing a hollow composite having an average particle diameter of 20 nm to 500 nm, as the hollow composite in which silica is doped with magnesium fluoride, but the method is related to a method of manufacturing hollow particles by preparing core and shell of silica particles through a sol-gel method and then removing the core. KR 101359848 only discloses a method of manufacturing hollow silica, which includes the steps of synthesizing silver nanocrystals by using a polyol solvent, synthesizing silver-silica core-shell nanoparticles by coating the silver nanocrystals with silica, and etching the silver core of the silver-silica core-shell nanoparticles, and hollow silica prepared accordingly. Therefore, it may be difficult to simply and stably manufacture hollow silica particles having physical properties, such as a high visible light transmittance, a high refractive index, a low thermal conductivity, a degree of monodispersion, a low oil absorption rate, and a high porosity, by hollow silica manufacturing techniques known to date. In addition, there is a limitation in that physical properties of conventional hollow silica are not sufficient to manufacture a thermal insulation sheet having excellent thermal insulation performance as well as transparency.

### DISCLOSURE OF THE INVENTION

### Technical Problem

The present invention provides hollow silica particles having a combination of advantageous physical properties, for example, low thermal conductivity as well as low refractive index. The present invention also provides a composition and a transparent thermal insulation sheet which include the hollow silica particles.

### Technical Solution

In accordance with an embodiment of the present invention, a hollow silica particle has complex physical properties in which a refractive index is 1.2 to 1.4, a thermal conductivity is less than 0.1 W/m·K, an oil absorption rate is 0.1 ml/g or less, a porosity is 90% or more when mixed with a resin, and a particle size distribution coefficient of variation (CV value) is 10% or less.

An average diameter of the particle may be 1 μm or less, an inner diameter of a hollow portion may be 10% to 90% of the average diameter of the particle, and a thickness of a shell may be 5% to 45% of the average particle diameter. For example, the hollow silica particle may have an average diameter of 500 nm or less and an inner diameter of the hollow portion of 40 nm or more. In order to maximize a filling rate of particles when manufacturing a thermal insulation sheet, the average diameter of the particle may be 500 nm or less and the inner diameter of the hollow portion may be 40 nm or more.

Also, the hollow silica particle may be formed from a phenyl-based silane, and an —OH group and a phenyl group are present as a functional group on a surface of the particle so that strength of the particle may be high.

Furthermore, with respect to the particle manufactured by a method of the present invention, since fine pores are hardly present on the surface of the particle, the oil absorption rate is 0.1 ml/g or less and the porosity is 90% or more when mixed with a resin. Thus, the collapse of particle shape and hollow does not occur when charged into a binder such as a resin. Accordingly, since particle properties, such as sphericity, average particle diameter, refractive index, and thermal conductivity, are not changed and stably maintained, the particle has properties suitable for being highly charged into the binder such as the resin.

The hollow particle of the present invention has a sphericity of 0.9 or more, wherein at least 90% of the silica particle is in the form of a sphere having a uniform convex grain contour in which a flat surface, corner, or recognizable recessed portion is not present.

In accordance with another embodiment of the present invention, a method of manufacturing hollow silica particles includes the following steps of:

(a) adding 0.1 mol % to 2 mol % of silane to an aqueous solution and stirring to generate silane droplets;

(b) adding an acid to the aqueous solution to hydrate the silane droplets;

(c) forming primary particles through bonding between the silane droplets by adding a basic aqueous solution to a reaction solution of step (b);

(d) forming a shell through polymerization of the primary particles by stirring the reaction solution to which the basic aqueous solution is added;

(e) etching inside of the shell with an organic solvent to form a hollow; and

(f) filtering and drying the solution.

In the above manufacturing method, the finally manufactured particles have an average diameter of 1 μm or less, and an inner diameter of a hollow portion is 10% to 90% of the average diameter of the particles.

The reaction solution has a pH of 1 to 5 after the adding of the acid in step (b), and hydration time in step (b) is in a range of 1 minute to 10 minutes.

The basic aqueous solution in step (c) has a pH of 10 or more, and the polymerization is performed to allow a thickness of the insoluble shell to be 5% to 45% of the average particle diameter.

The silane includes at least one selected from the group consisting of phenyl-based silane, tetraethyl orthosilicate (TEOS), tetramethyl orthosilicate (TMOS), SiCl₄, and silane having an organic group other than a phenyl group, or a mixture thereof. In a case in which a mixture of the phenyl-based silane and the other silane is used, 80 wt % or more of the phenyl-based silane and 20 wt % or less of the other silane may be mixed and used, and phenyltrimethoxysilane (PTMS) may be used as the phenyl-based silane.

The basic solution in step (d) includes NH₄OH or an inorganic base, such as alkylamines, and the alkylamine is selected from the group consisting of tetramethyl ammonium hydroxide (TMAH), octylamine (OA, CH₃(CH₂)₆CH₂H₂), dodecylamine (DDA, CH₃(CH₂)₁₀CH₂NH₂), hexadecylamine (HDA, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

Reaction temperatures in step (b) and step (d) may be in a range of 40° C. to 80° C., and the method may prepare a smoother surface by further including a step of (g) performing sonication on a filtrate after the filtering in step (f).

The drying after the filtering may be performed at a temperature of 250° C. or less, for example, 150° C. or less.

The method may further include a step of (i) modifying surfaces of the hollow silica particles after step (0, and the use of the particles may be expanded by providing a functional group on the surface of the particles.

In accordance with another embodiment of the present invention, a composition includes the hollow silica particles of the present invention, a resin, and a solvent. The hollow silica particles may be included in an amount of 30 wt % to 80 wt % and the resin may be included in an amount of 20 wt % to 70 wt % based on the total composition.

The resin in the composition may have a refractive index of less than 1.5, and at least one selected from the group consisting of an acrylate-based polymer resin, a polyimide (PI) resin, a C-polyvinyl chloride (PVC) resin, a polyvinylidene fluoride (PVDF) resin, an acrylonitrile butadiene styrene (ABS) resin, and chlorotrifluoroethylene (CTFE), or a mixture thereof may be used.

Also, the composition may further include at least one selected from the group consisting of a hard coating agent, an ultraviolet (UV) blocking agent, or an infrared (IR) blocking agent to provide additional functionality.

In accordance with another embodiment of the present invention, a thermal insulation sheet having a visible light transmittance of 70% or more, a thermal conductivity of less than 0.1 W/m·K, and a filling rate of hollow silica particles of 30% to 80% is manufactured by preparing a base material, forming a coating layer by coating the base material with the composition, and curing the coating layer. The coating layer may further have a UV and IR blocking function. A sheet of a polymer material, a textile, a film, or glass may be used as the base material of the thermal insulation sheet.

### Advantageous Effects

According to the present invention, hollow silica particles having properties, such as a refractive index of 1.2 to 1.4, a thermal conductivity of less than 0.1 W/m·K, an oil absorption rate of 0.1 ml/g or less, a porosity of 90% or more when mixed with a resin, and a particle size distribution coefficient of variation (CV value) of 10% or less, may be provided by a simple and stable manufacturing method.

Also, a composition, which includes the hollow silica particles having the above physical properties, may be provided, and accordingly, a thermal insulation sheet having excellent thermal insulation performance as well as transparency may be provided in which a visible light transmittance is 70% or more, a thermal conductivity is less than 0.1 W/m·K, and a particle filling rate is 30% to 80%.

### BRIEF DESCRIPTION OF THE DRAWINGS

FIG. 1 is schematic views illustrating a hydrated phenyltrimethoxysilane (PTMS) droplet, a primary particle, and a structure of a particle having a shell formed thereon in a manufacturing process of the present invention;

FIG. 2 is transmission electron microscope (TEM) images of hollow silica particles having an average particle diameter of 100 nm according to an example of the present invention;

FIG. 3 is TEM images of particles which are formed during a reaction at a temperature of 85° C. according to a comparative example;

FIG. 4 is TEM images obtained by hydrolyzing the silica particles according to the example of the present invention at 60° C. for 30 seconds and then etching the silica particles;

FIG. 5 is TEM images of particles after the sonication of the particles of FIG. 4; and

FIG. 6 is TEM images of particles of the present invention which are obtained after polyphenylsilsesquioxane (PPSQ) is polymerized, cleaned, dispersed in methanol, and then etched.

### MODE FOR CARRYING OUT THE INVENTION

A manufacturing process and physical properties of hollow silica particles of the present invention will be described in detail.

Manufacture of Hollow Silica Particles

With respect to hollow silica particles of the present invention, silane is used as a starting raw material, is stirred in an aqueous solution to generate droplets, and is then hydrated by adding an acid. Then, primary particles are formed through bonding between the droplets by adding a basic aqueous solution and are then polymerized to form a shell. Then, the inside of the shell is etched with an organic solvent to form a hollow and final hollow silica particle powder is manufactured through filtration and drying. In this case, a step of performing sonication on the filtrate may be further included.

1. Raw Material

At least one selected from the group consisting of phenyl-based silane, tetraethyl orthosilicate (TEOS), tetramethyl orthosilicate (TMOS), SiCl₄, and silane having an organic group other than a phenyl group, or a mixture thereof may be used as a raw material of hollow silica particles. In a case in which a mixture of the phenyl-based silane and the other silane is used, 80 wt % or more of the phenyl-based silane and 20 wt % or less of the other silane may be mixed and used, and particularly, phenyltrimethoxysilane (PTMS, C₉H₁₄O₃Si) having a structure of the following Formula 1 may be used as the phenyl-based silane.

In a case in which the PTMS and at least one silane selected from TEOS, TMOS, SiCl₄, and silane having an organic group other than a phenyl group are mixed and used, the PTMS and the at least one silane may be mixed in a weight ratio of 4:1.

As a concentration of the silane, when the silane is used in an amount of 0.1 mol % or less in the aqueous solution, small particles having a diameter of about 1 μm or less may be obtained.

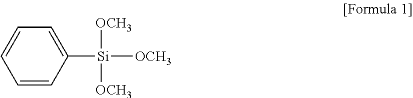 [SMILES: CO[Si](OC)(OC)c1ccccc1]

2. Droplet Generation

When 0.1 mol % to 2 mol % of the silane is added to the aqueous solution, the silane is not mixed with the aqueous solution, and thus, separation occurs. When the aqueous solution is continuously stirred, silane droplets are formed and dispersed in the aqueous solution.

3. Droplet Hydration

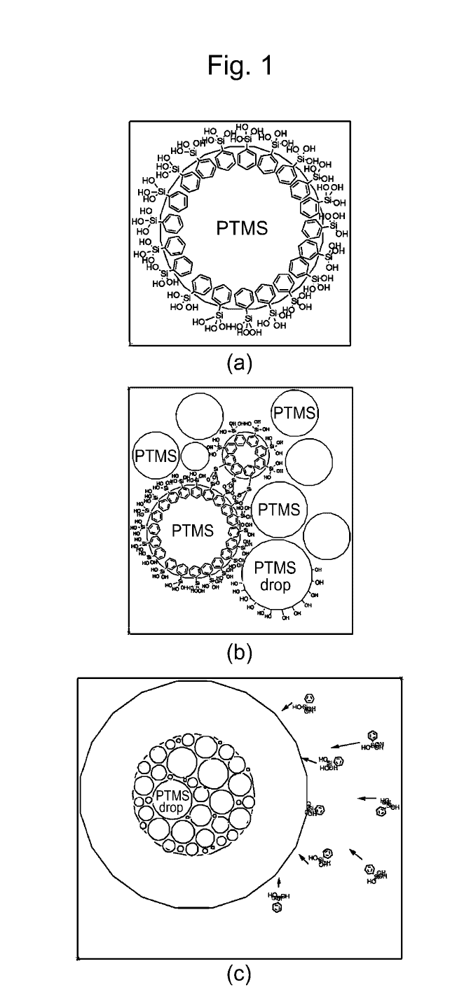

When an acid is added to the aqueous solution, —OR groups of the silane are substituted with —OH groups by the catalytic role of the acid as illustrated in (a) of FIG. 1, and when the aqueous solution is continuously stirred, hydrated silane droplets are uniformly mixed with the aqueous solution. HCl, HNO₃, or H₂SO₄ may be used as the acid, and a reaction solution may have a pH of 0.5 to 5. In this case, since chains of the silane are cut off as the pH of the reaction solution is low, the diameter of the particle is decreased. Thus, when the reaction solution is highly acidic at a pH of 1, a small amount of the silane must be used. The reason for this is that since the reaction easily proceeds in the form of a gel or a hollow is not formed in the particle when the amount of the silane is large, it is difficult to control the particle generation. Also, if the pH is 5 or more, particle and hollow may not be formed when a small amount of the silane is used.

The diameter of the finally formed particle becomes smaller as the stirring time increases after the addition of the acid, but the particles are agglomerated to be a gel so that the hollow is difficult to be formed. When the stirring time is excessively short, the hydration of the silane droplets insufficiently occurs, and thus, it is difficult to form hollow particles. Thus, the stirring time may be between 0.5 minutes to 10 minutes, for example, 1 minute to 5 minutes.

There is no difference between diameters of the droplet when a size of a stirrer to that of a reactor is about 80% and stirring speed is greater than 200 rpm, but, since the particle diameter increases when the stirring speed is 200 rpm or less, the stirring speed may be 200 rpm or more. The diameter of the hydrated droplet may be in a range of 8 μm to 12 μm, and the final particle diameter is determined depending on the diameter of the droplet.

A temperature of the reaction may be in a range of 40° C. to 80° C. The particle generation may be difficult at a temperature of less than 40° C., and, at a high concentration, the particles may be agglomerated to be easily in the form of a gel and a thickness of the shell may be increased to reduce a diameter of the hollow. In a case in which the temperature is greater than 80° C., it is difficult to control reaction conditions due to the evaporation of the base, and hollow particles are not formed because the inside of the shell is not melted. A hydration equation of PTMS is as follows.

[Reaction Equation 1]

PhSi(OMt)₃+H₂O->PhSi(OH)(OMt)₂

PhSi(OH)(OMt)₂+H₂O->PhSi(OH)₂(OMt)

PhSi(OH)₂(OMt)+H₂O->PhSi(OH)₃

4. Primary Particle Formation

When a basic solution is added to the solution in which the silane is hydrated, the basic solution acts as a catalyst to form primary particles due to a reaction between the silane droplets as illustrated in (b) of FIG. 1. A base, such as NaOH, Ca(OH)₂, KOH, and NH₄OH, for example, NH₄OH or an inorganic base, such as alkylamines, is used as the basic solution, and the total reaction solution is allowed to have a pH of 10 or more. The alkylamine is selected from the group consisting of tetramethyl ammonium hydroxide (TMAH), octylamine (OA, CH₃(CH₂)₆CH₂H₂), dodecylamine (DDA, CH₃(CH₂)₁₀CH₂NH₂), hexadecylamine (HDA, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylamino ethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

When the reaction temperature is less than 40° C., since the particles are agglomerated to be easily in the form of a gel, the generation of the hollow particles may be difficult and the thickness of the shell may be increased to reduce the diameter of the hollow. When the temperature is greater than 80° C., it is difficult to control reaction conditions due to the evaporation of the base, and hollow particles are not formed because the inside of the shell is not melted. Thus, the reaction may be performed in a temperature range of 40° C. to 80° C.

2Ph-Si(OH)₃→Ph-Si(OH)₂—O—Si(OH)₂-Ph [Reaction Equation 2]

5. Shell Formation

The aqueous solution, to which the basic solution is added, is stirred to polymerize the primary particles through siloxane bonds and thus, a shell, which is insoluble in an organic solvent, is formed. The thickness of the shell may be 5% to 45% of an average diameter of the silica particle. In a case in which PTMS is used as a raw material to form particles, the shell may have a networked polyphenylsilsesquioxane (PPSQ) structure.

Ph-Si(OH)₂—O—Si(OH)₂-Ph→+n[Ph-Si(OH)₃]→networked polyphenylsilsesquioxane (PPSQ) [Reaction Equation 3]

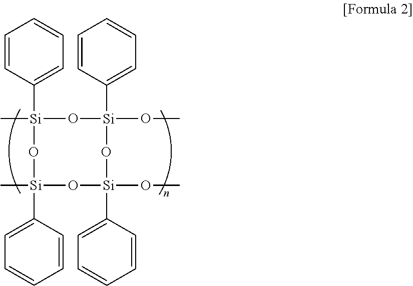

6. Etching

A silane oligomer and an unreacted droplet are present in the inside of the insoluble shell, and the silane oligomer and unreacted droplet are etched using an organic solvent to form a hollow in the inside of the shell.

Any organic solvent generally used, including ethanol or methanol, may be used as the organic solvent.

Sonication is further performed on the filtrate using a sonicator to remove impurities on the surfaces of the particles, and thus, the surfaces of the particles may be made smoother. The sonication may be performed for 5 seconds to 40 minutes.

7. Filtration and Drying

When the filtrate is dried at a temperature of less than 250° C., for example, 150° C., in a vacuum oven for 1 hour to 10 hours, evaporation or sublimation of moisture occurs at a temperature corresponding to vacuum, and thus, the filtrate is dried.

A step of modifying the surface of the particles by a known method, such as nitrification, sulfonation, amination, and halogenation, through the treatment of the formed hollow silica particles with a silane coupling agent may be further included. A silane-based, aluminum-based, titanium-based, or zirconium-based coupling agent may be used as the silane coupling agent. The hollow silica particles thus surface modified may be used in various areas such as functional ceramics, microcapsules, nanoreactors, drug delivery systems (DDS), catalysts, and sensors. When the surface is treated with the surface treatment agent as described above, dispersibility in a hydrophobic dispersion medium, such as a resin or an organic solvent, is improved, and adhesion to the resin or peel strength may also be improved.

Also, since a template is not required during the manufacture of the hollow particles and a sintering process requiring a lot of time and high energy costs is not necessary, hollow silica particles may be obtained by a simple manufacturing process.

Hollow Silica Particles

The hollow silica particles manufactured by the above manufacturing method have monodisperse physical properties, such as a refractive index of 1.2 to 1.4, a thermal conductivity of less than 0.1 W/m·K, an oil absorption rate of 0.1 ml/g or less, a porosity of 90% or more when mixed with a resin, and a particle size distribution coefficient of variation (CV value) of 10% or less. Also, the hollow silica particles are true spherical particles in which an average diameter of the particles is 1 μm or less, an inner diameter of a hollow portion is 10% to 90% of the average diameter of the particles, the thickness of the shell is 5% to 45% of the average particle diameter, and a sphericity is 0.9 or more.

Hereinafter, physical properties of the hollow silica particles of the present invention and measurement methods thereof will be described.

1) Refractive Index

First, hollow silica is dispersed in a sorbitol syrup (70% sorbitol)/water mixture. Degassing is generally performed for 1 hour, light transparency of the dispersed solution is then measured at 589 nm by using a spectrophotometer, and water is used as a blind sample. A refractive index of each dispersed solution is measured using an Abbe refractometer. A range of the refractive index, in which the light transmittance is greater than 70%, may be obtained from a graph of the light transmittance versus the refractive index. The maximum light transmittance of the sample and a refractive index, from which the maximum light transmittance is obtained, may also be obtained from the graph.

2) Thermal Conductivity

For the measurement of thermal conductivity, the center of a thermal insulation sheet having a length of 30 cm, a width of 30 cm, and a thickness of 5 cm is cut into the shape of a square with a length of 24 cm and a width of 24 cm to form a frame. An aluminum foil having a length of 30 cm and a width of 30 cm is adhered to one side of the frame to form a recessed portion and it is used as a sample stand. Also, a surface covered with the aluminum foil is determined as a bottom surface of the sample stand and another surface in a thickness direction of the thermal insulation sheet is determined as a top surface. Thermal insulation material powder is charged into the recessed portion without tapping or pressurization to perform leveling, and an aluminum foil having a length of 30 cm and a width of 30 cm disposed on the top surface is used as a measurement sample. Thermal conductivity of the measurement sample at 30° C. is measured using a heat flow meter, HFM 436 Lambda (brand name, manufactured by NETZSCH Group). According to JIS A 1412-2, calibration is performed in advance using a NIST SRM 1450c standard plate for calibration having a density of 163.12 kg/m³ and a thickness of 25.32 mm at 15° C., 20° C., 24° C., 30° C., 40° C., 50° C., 60° C., and 65° C. under a condition in which a temperature difference between a high-temperature side and a low-temperature side is 20° C. Thermal conductivity at 800° C. is measured according to the method of JIS A 1421-1. Two disc-shaped thermal insulation sheets having a diameter of 30 cm and a thickness of 20 mm are used as measurement samples, and a guarded hot plate method thermal conductivity instrument (manufactured by Eiko Seiki Co., Ltd.) is used as a measuring instrument.

3) Oil Absorption Rate

The hollow silica particles of the present invention have characteristics in that their spherical surfaces are substantially smooth even if separate sintering and surface treatment are not performed after the manufacture of the particles. Herein, the term “smooth” denotes that fine pores are hardly present on the surfaces and there are no random uneven portions, such as depressions, gaps, flaws, cracks, protrusions, and grooves, on the surface of the shell. These surface characteristics are absent for hollow silica particles obtained by a conventional manufacturing method. Smoothness of the particles of the present invention may be measured by a scanning electron microscope and may be confirmed by the oil absorption rate and the porosity when mixed with a resin.

The oil absorption rate was measured by using a rub-out method (ASTM D281). The method is based on a principle in which linseed oil is mixed with silica by rubbing a linseed oil/silica mixture on a smooth surface using a spatula until a stiff putty paste is formed. An oil absorption rate of silica may be calculated by measuring the amount of the oil which is required to obtain a paste mixture curled when sprayed, wherein this represents a volume of the oil which is required for unit weight of the silica in order to saturate silica adsorption capacity. A high oil absorption level denotes that the plurality of fine pores is present on the surface or the diameter of the fine pores is large, and a low oil absorption level denotes that fine pores are hardly present on the surface of the shell of the silica particles. The oil absorption rate may be determined by the following equation.

Oil absorption rate=amount of oil ml/silica 100 g

4) Porosity

Porosity may be identified by an amount of a resin soaked into a hollow when the hollow silica particles are mixed with the resin. The amount of the resin soaked into the hollow is measured in the same manner as the oil absorption rate and a small amount of the resin indicates that the hollow is maintained.

That is, a structure, in which the surface of particles is smooth and fine pores are hardly present, denotes that, in a case in which the hollow silica particles are charged into a resin, since the resin constituting a binder or oil is not soaked into the hollow of the particles, the porosity is increased to obtain transparency and low thermal conductivity of the particles, and an increase in transparent thermal insulation performance of the thermal insulation sheet coated with a composition including the above particles is possible.

5) Particle Size Distribution Coefficient of Variation (CV Value) (Degree of Monodispersion)

Particles were imaged using a scanning electron microscope (×250,000) and an average particle diameter of 25 particles of the image was measured using an image analysis system to calculate a coefficient of variation (CV value) for particle diameter distribution. Specifically, for 250 particles, a diameter of each particle was measured and an average particle diameter and a standard deviation of the particle diameter were obtained from the measured diameter values to calculate the coefficient of variation from the following equation.

Particle size distribution coefficient of variation (CVD (%))=(standard deviation of particle diameter (σ)/average particle diameter (Dn))×100

6) Sphericity

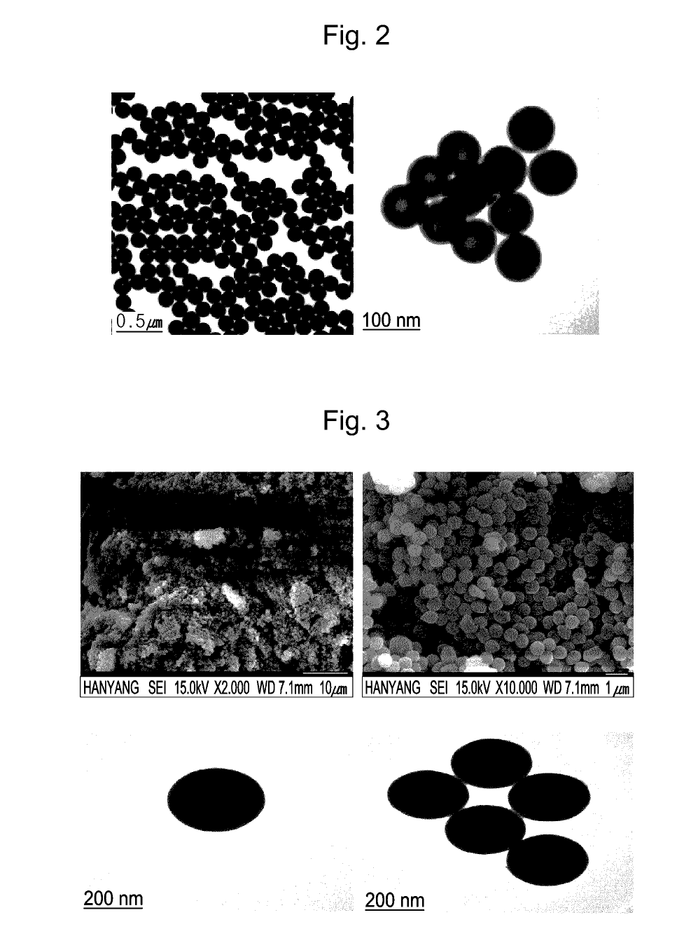

Characteristics of the silica particles of the present invention having a very round shape are analyzed by measuring scanning electron microscope (SEM) images illustrating a cross-sectional structure of the particle and are represented by a ratio (DS/DL) of a short diameter (DS) to a long diameter (DL). A representative sample of the silica particles was collected and tested by an SEM. As illustrated in the electron microscope image of FIG. 2, a sphericity (S₈₀) of the particles of the present invention is 0.9 or more, and thus, it may be understood that the particles of the present invention are spherical particles close to a true sphere. The expression “S₈₀” used in the present application is defined and calculated as follows. An SEM image magnified 20,000 times, as a representative example of the silica particle sample, is loaded into a photo imaging software and a contour (two-dimensional) of each particle is traced. Particles, which are in close proximity to each other but are not attached to each other, must be considered as separate particles for evaluation. The particles subjected to contour analysis are subsequently filled with a color, and the image is loaded into a particle characterization software (for example, MAGE-PRO PLUS available from Media Cybernetics, Inc. (Bethesda, Md.)) that may determine a circumference and an area of the particle. The sphericity of the particle may be subsequently calculated by the following equation.

Sphericity=circumference²/4π×area

In the above equation, the circumference is a software measured circumference which is derived from the contour analyzed trace of the particle, and the area is a software measured area within the traced circumference of the particle. The above calculation is performed on each particle that is entirely appropriate in the SEM image. These values are subsequently classified according to a value, and the bottom 20% of these values are discarded. The remaining 80% of these values are averaged to obtain the S₈₀. It was confirmed that the sphericity (S₈₀) of the particles of FIG. 2 was 0.98.

7) Average Particle Diameter and Thickness of Shell

“Average diameter” is understood as a diameter which is averaged for all particles in the sample.

A representative sample of the silica particles was collected and a diameter of the silica particles was measured by an SEM. An inner diameter of the hollow portion was measured by a transmission electron microscope (TEM).

An average diameter of the hollow particles of the present invention is generally 1 μm or less, particularly, 500 nm or less, and more particularly, 100 nm or less. In a case in which the average diameter is greater than 1 μm, since the hollow particles may not be completely filled within the thickness of the coating layer during the manufacture of the thermal insulation sheet, a filling rate may be reduced. Thus, a targeted thermal insulation effect may not be achieved.

The hollow silica particles of the present invention are particles in which the average diameter is 1 μm or less, and the inner diameter of the hollow portion is 10% to 90% of the average diameter of the particles. With respect to particles having an average diameter of 100 nm, the thermal insulation effect was good when the inner diameter of the hollow portion was 40 nm or more. Since the hollow silica particles are stable during the reaction when the thickness of the shell is 5% to 45% of the average particle diameter, the hollow silica particles may be used as a thermal insulation material.

8) Functional Group

Also, in a case in which phenyl-based silane is used as a raw material, the particles have an —OH group and a phenyl group as a functional group on the surfaces thereof, and, since a refractive index may be increased due to the phenyl group in comparison to other silica particles, the particles may have a refractive index similar to that of a resin. Thus, a transparent thermal insulation sheet may be manufactured because a difference in the refractive indices between the particles and the resin may be minimized.

Coating Composition Including Hollow Silica Particles and Resin

According to another embodiment of the present invention, a composition for forming a transparent thermal insulation coating layer on a base material is provided. The composition of the present invention may be prepared by mixing the hollow silica particles having complex physical properties as described above, a resin, and an organic solvent.

The hollow silica particles may be included in an amount of 30 wt % to 80 wt % in a total composition of the present invention. In a case in which the amount is less than 30 wt %, thermal insulation performance of the coating layer may not be achieved, and, in a case in which the amount is greater than 80 wt %, the transparency may decrease and the amount of the resin may be reduced to reduce a curing efficiency.

The resin may be included in an amount of 20 wt % to 70 wt % in the total composition of the present invention. In order to prepare a transparent liquid by controlling a refractive index with respect to the silica particles, the refractive index of the resin may be less than 1.5, and a resin having a refractive index similar to that of the hollow particles may be selected among ultraviolet (UV)-curable resins and used.

Examples of the UV-curable resin may be a urethane resin, an acryl resin, a polyester resin, an epoxy resin, and a mixture thereof, but the present invention is not limited thereto. At least one of an acrylate-based polymer resin, a polyimide (PI) resin, a C-polyvinyl chloride (PVC) resin, a polyvinylidene fluoride (PVDF) resin (heat resistance temperature of about 300° C.), an acrylonitrile butadiene styrene (ABS) resin, and chlorotrifluoroethylene (CTFE), or a mixture thereof may be used as a resin having low thermal conductivity.

The composition may further include a hard coating agent, a UV blocking agent, or an infrared (IR) blocking agent, and a known additive may be used as the above additive, but an additive providing additional functions may be further included if necessary.

The “composition” used in the present application denotes any liquid, liquefiable, or mastic composition including silica which is converted into a solid film after the application to the base material. The composition may be applied to an inner or outer surface of any structure.

The composition includes a hollow silica particle product and the silica product described in the present application has specific physical properties including hardness, sphericity, refractive index, oil absorption rate, and thermal conductivity which are useful to provide thermal insulation and transparency of the composition. The composition may be any coating composition and may be applied to any base material. Since the composition exhibits excellent transparency and thermal insulation while maintaining integrity of a polymer and pigment matrix that may exist in the coating, the composition is suitable for a coating on thermal insulation sheets, windows in housing and construction sectors, and car windows. Also, since the composition described in the present application not only exhibits excellent thermal insulation and transparent characteristics but also improves physical properties of a formulation, the composition is suitable for a plastic compound and a masterbatch formulation.

Thermal Insulation Sheet

According to another embodiment of the present invention, a thermal insulation sheet may be manufactured by preparing a base material and forming a coating layer by laminating or coating and UV curing the composition of the present invention on the base material. Any appropriate coating method known in the art may be used as the coating method, and examples of the known method may be gravure coating, offset gravure coating, two and three roll pressure coating, two and three roll reverse coating, one and two roll kiss coating, trailing blade coating, nip coating, flexographic coating, inverted knife coating, polishing bar coating, and wire wound doctor coating. After the coating, the coating layer is cured by UV light and the curing treatment is usually completed in a relatively short period time of about 1 second to about 60 seconds.

The base material, on which the coating layer is formed by using the composition, is not particularly limited, but, for example, may include inorganic base materials represented by glass, metal base materials, and organic base materials represented by polycarbonate or polyethylene terephthalate, an acryl resin, a fluorine resin, triacetyl cellulose, and a polyimide resin. For example, the base material may include a sheet of a polymer material, a textile, a film, or glass, and particularly, a film base material may include a generally applicable film such as polyethylene terephthalate (PET) and polyethylene (PE). The same base material may be used alone, and a base material, in which different materials are laminated, may be used. Also, at least one layer of different layers may be formed in advance on the surface of the base material. Examples of the different layer may be an ultraviolet curable hard coat layer, an electron beam curable hard coat layer, and a thermosetting hard coat layer.

A thickness of the coating layer may be arbitrarily selected and adjusted depending on the product and use, the coating may be performed to a thickness of 1 μm to 500 μm, and, when the thickness is outside the above range, the thermal conductivity may be increased or the visible light transmittance may be reduced. The coating layer may further have a UV and IR blocking function, and a UV blocking layer and an IR blocking layer may be separately laminated on the coating layer. The thermal insulation sheet using the composition according to the present invention may have a particle filling rate of 30% to 80%, a visible light transmittance of 70% or more, and a thermal conductivity of less than 0.1 w/m·k, and thus, may have transparent thermal insulation properties.

Hereinafter, the present invention will be explained in more detail by way of exemplary embodiments. These embodiments are intended to only illustrate the present invention, and it will be obvious to those skilled in the art that the scope of the present invention is not construed as being limited to these embodiments. Further, simple changes and modifications of the present invention are appreciated as included in the scope of the invention.

Various physical properties of hollow silica particles and thermal insulation sheets of examples and comparative examples were measured by the above-described methods.

### EXAMPLE 1

Water (150 ml) and phenyltrimethoxysilane (PTMS) (1 ml) were put in a 250 ml flask and nitric acid (60%, 0.2 ml, 2.6 mmol) was then added thereto and stirred at 60° C. for 4 minutes. Subsequently, ammonia water (30%, 10 ml, 308 mmol) was added to a reaction solution and stirred at 60° C. for 1 hour and 30 minutes to form a shell, and the inside of the shell was etched with ethanol. The reactant thus obtained was filtered and dried at 120° C. to obtain hollow silica particles.

As illustrated in the transmission electron microscope (TEM) images of FIG. 2, the particles obtained were monodisperse spherical particles and hollow particles in which a hollow, which was seen to be bright, was formed. Refractive index, thermal conductivity, oil absorption rate, porosity when mixed with a resin, and particle distribution coefficient of variation (CV value) of the particles are presented in Table 1.

### EXAMPLE 2

Hollow silica particles were obtained in the same manner as in Example 1 except that phenyltrimethoxysilane (PTMS) (0.8 ml) and TEOS (0.2 ml) were mixed and used as the silane in Example 1, and physical properties of the particles obtained are presented in Table 1.

### EXAMPLE 3

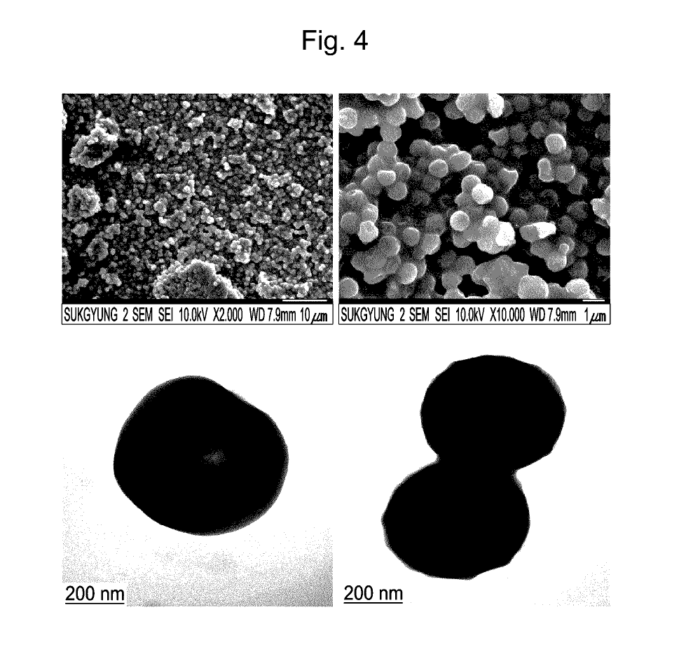

In Example 3, after the acidic solution was added in Example 1, the stirring times were respectively set as 9 minutes to manufacture particles. The manufactured particles formed monodisperse spherical hollow particles as illustrated in FIG. 4, and physical properties are presented in Table 1.

### EXAMPLE 4

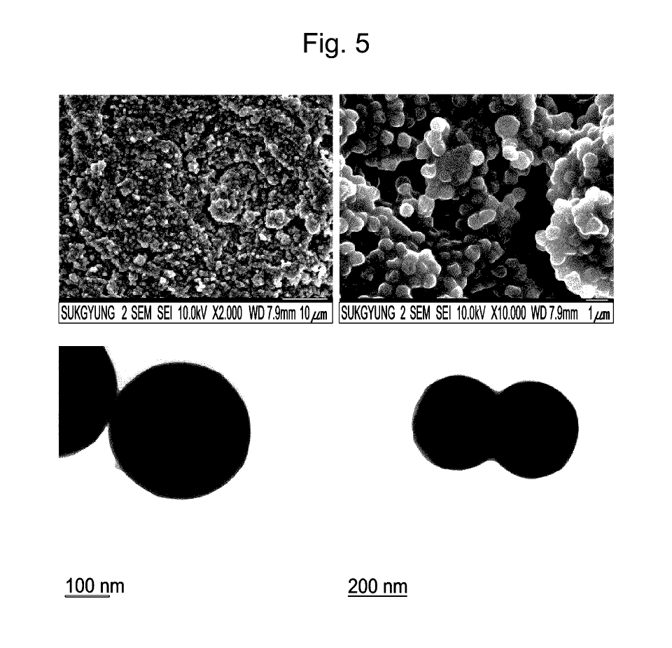

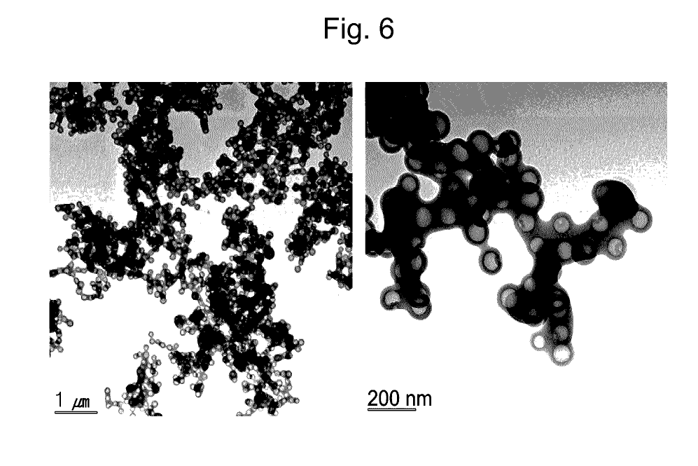

In Example 4, sonication was further performed in Example 1 to manufacture particles. The manufactured particles formed monodisperse spherical hollow particles as illustrated in FIG. 5, and had a smooth surface almost without impurities and a true sphere shape in comparison to the particles of Example 3. Physical properties are presented in Table 1.

### COMPARATIVE EXAMPLES 1 AND 2

In Comparative Examples 1 and 2, reactions were performed in the same manner as in Example 1 except that the reactions were respectively performed at 30° C. and 85° C. instead of the reaction temperature in Example 1.

In Comparative Example 1, particles were not formed, and, in Comparative Example 2, particles were formed, but a hollow was not present as in FIG. 3.

### COMPARATIVE EXAMPLE 3

In Comparative Example 3, after the addition of the acidic solution as described in Example 1, stirring was performed for 15 minutes, and the results of the reaction are presented in Table 1. Final particles were gelated and hollow particles were not formed. This seemed to be due to the fact that small particles were agglomerated because the stirring time was excessively increased.

### COMPARATIVE EXAMPLE 4

In Comparative Example 4, hollow silica particles were obtained in the same manner as in Example 1 except that the concentration of the silane in Example 1 was changed to 0.5 mol %. As a result, hollow particles were formed, but a diameter of the particles was greater than 1 μm and physical properties suitable for the manufacture of a thermal insulation sheet were not obtained.

TABLE 1

| | Hollow | | Thermal | | Average | Oil | |
|---|---|---|---|---|---|---|---|
| | particle | Refractive | conductivity | | particle | absorption | |
| | formation | index | (W/m · K) | CV (%) | diameter | rate (ml/g) | Porosity (%) |
| Example 1 | Formed | 1.36 | 0.03 | 3 | 100 nm | 0.018 | 90 |
| Example 2 | Formed | 1.34 | 0.03 | 3.8 | 180 nm | 0.015 | 95 |
| Example 3 | Formed | 1.29 | 0.03 | 4 | 100 nm | 0.018 | 92 |
| Example 4 | Formed | 1.37 | 0.03 | 3 | 200 nm | 0.021 | 93 |
| Comparative | Not formed | — | — | — | — | — | — |
| Example 1 | | | | | | | |
| Comparative | Not formed | 1.45 | 0.043 | 4 | 100 nm | — | — |
| Example 2 | | | | | | | |
| Comparative | Not formed | — | — | — | — | — | — |
| Example 3 | | | | | | | |
| Comparative | Formed | 1.36 | 0.047 | — | 2.4 μm | 0.019 | — |
| Example 4 | | | | | | | |

### EXAMPLE 5

A composition was prepared by mixing 60 wt % of the hollow silica particles manufactured according to Example 1 based on the total composition, 30 wt % of polyimide (PI) resin, and organic solvent and initiator as a remainder. One side of a PET film was coated with the prepared composition by bar coating and was cured for 20 seconds by using a UV lamp to manufacture a thermal insulation sheet on which a 125 thick coating layer was formed. Measurement results of physical properties of the thermal insulation sheet are presented in Table 2.

### EXAMPLES 6 AND 7

In Examples 6 and 7, compositions were prepared by respectively mixing the hollow silica particles in ratios of 30 wt % and 80 wt % based on the total composition in Example 5 and thermal insulation sheets were then manufactured. Measurement results of physical properties are presented in Table 2.

### COMPARATIVE EXAMPLES 5 AND 6

Compositions were prepared by respectively mixing the hollow silica particles in ratios of 20 wt % and 90 wt % based on the total composition in Example 5, and, since coating was difficult due to high viscosity of the liquid when the amount of the hollow particles was 50% or more, methyl ethyl ketone (MEK) as an organic solvent was used to adjust the viscosity to be low. Then, thermal insulation sheets were manufactured and measurement results of physical properties are presented in Table 2.

### COMPARATIVE EXAMPLE 7

A thermal insulation sheet was manufactured in the same manner as in Example 5 except that hollow particles having a diameter of 200 nm and an inner diameter of a hollow portion of 100 nm, which were manufactured by a conventional template synthesis method, were used, and measurement results of physical properties of the thermal insulation sheet are presented in Table 2. In the thermal insulation sheet, since the particles were not dispersed in the composition and escaped from the resin during coating and UV curing, a coating layer may not be formed.

In Examples 5 to 7 and Comparative Examples 5 to 7, since the viscosity of the liquid was excessively high when the mixing ratio of the hollow particles was greater than 50%, an organic solvent having a low boiling point (BP) was added to reduce the viscosity. Then, coating was performed, a solvent was evaporated by primary drying, and UV curing was performed.

TABLE 2

| | Particle | Dilution solvent | | |
|---|---|---|---|---|
| | mixing | MEK (% with | Visible light | Thermal |
| | ratio | respect to hollow | transmittance | conductivity |
| | (%) | particles) | (%) | (W/m · K) |
| Example 5 | 60 | 10 | 90 | 0.05 |
| Example 6 | 30 | — | 92 | 0.08 |
| Example 7 | 80 | 30 | 87 | 0.03 |
| Comparative | 90 | 40 | 60 | 0.03 |
| Example 5 | | | | |
| Comparative | 20 | — | 80 | 0.23 |
| Example 6 | | | | |
| Comparative | 60 | 10 | — | — |
| Example 7 | | | | |

As illustrated in Table 2, it may be understood that, since the visible light transmittance was high when the mixing ratio of the hollow particles was less than 30 wt % based on the total composition, the thermal insulation sheet was transparent but the thermal insulation efficiency was decreased due to the low air content. In contrast, it may be understood that, since the visible light transmittance was reduced when the mixing ratio of the hollow particles was greater than 80 wt %, the thermal insulation sheet was opaque and the curing efficiency was reduced due to a decrease in the amount of the curing resin.

Also, in the particles manufactured according to Comparative Example 7, large-sized pores were present on surfaces of the particles. The resin was infiltrated into the hollow through the pores on the surfaces during mixing with the UV curable resin, and since the particles were not dispersed in the composition and escaped from the resin during the coating and UV curing, a coating layer may not be formed. Thus, it is considered that it is difficult to manufacture a transparent thermal insulation sheet having the properties of the present invention by using conventional hollow silica particles.

1. A hollow silica particle having a refractive index of 1.2 to 1.4, a thermal conductivity of less than 0.1 W/m·K, an oil absorption rate of 0.1 ml/g or less, a porosity of 90% or more when mixed with a resin, and a particle size distribution coefficient of variation (CV value) of 10% or less.

2. The hollow silica particle of claim 1, wherein an average diameter of the particle is 1 μm or less, and an inner diameter of a hollow portion is 10% to 90% of the average diameter of the particle.

3. The hollow silica particle of claim 1, wherein the particle has a sphericity of 0.9 or more.

4. The hollow silica particle of claim 1, wherein a surface of the particle has an —OH group and a phenyl group as a functional group.

5. The hollow silica particle of claim 1, wherein a thickness of a shell is 5% to 45% of the average particle diameter.

6. A method of manufacturing hollow silica particles, the method comprising steps of:
(a) adding 0.1 mol % to 2 mol % of silane to an aqueous solution and stirring to generate silane droplets;
(b) adding an acid to the aqueous solution to hydrate the silane droplets;
(c) forming primary particles through bonding between the silane droplets by adding a basic aqueous solution to a reaction solution of step (b);
(d) forming a shell through polymerization of the primary particles by stirring the reaction solution to which the basic aqueous solution is added;
(e) etching inside of the shell with an organic solvent to form a hollow; and
(f) filtering and drying the solution.

7. The method of claim 6, wherein the primary particles have a polyphenylsilsesquioxane (PPSQ) structure.

8. The method of claim 6, wherein the reaction solution has a pH of 1 to 5 after the adding of the acid in step (b).

9. The method of claim 6, wherein stirring time in step (b) is in a range of 0.5 minutes to 10 minutes.

10. The method of claim 6, wherein the reaction solution has a pH of 10 or more after the adding of the basic solution in step (c).

11. The method of claim 6, wherein a thickness of the insoluble shell is 5% to 45% of an average particle diameter.

12. The method of claim 6, wherein the silane comprises at least one selected from the group consisting of phenyl-based silane, tetraethyl orthosilicate (TEOS), tetramethyl orthosilicate (TMOS), SiCl₄, and silane having an organic group other than a phenyl group, or a mixture thereof.

13. The method of claim 12, wherein the phenyl-based silane is phenyltrimethoxysilane (PTMS).

14. The method of claim 12, wherein the mixture of the silanes comprises 80 wt % or more of the phenyl-based silane and 20 wt % or less of the other silane.

15. The method of claim 6, wherein the basic solution comprises NH₄OH, or an alkylamine solution selected from the group consisting of tetramethyl ammonium hydroxide (TMAH), octylamine (OA, CH₃(CH₂)₆CH₂H₂), dodecylamine (DDA, CH₃(CH₂)₁₀CH₂NH₂), hexadecylamine (HDA, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

16. The method of claim 6, wherein reaction temperatures in step (b) and step (d) are in a range of 40° C. to 80° C.

17. The method of claim 6, further comprising a step of (g) performing sonication on a filtrate after the filtering in step (f).

18. The method of claim 6, wherein drying temperature is 250° C. or less.

19. The method of claim 6, further comprising a step of (i) modifying surfaces of the hollow silica particles after step (f).

20. A composition comprising the hollow silica particles of claim 1, a resin, and a solvent.

21. The composition of claim 20, wherein the hollow silica particles are included in an amount of 30 wt % to 80 wt % based on the total composition.

22. The composition of claim 20, wherein the resin is included in an amount of 20 wt % to 70 wt % based on the total composition.

23. The composition of claim 20, wherein the resin has a refractive index of less than 1.5.

24. The composition of claim 20, wherein the resin comprises at least one selected from the group consisting of an acrylate-based polymer resin, a polyimide (PI) resin, a C-polyvinyl chloride (PVC) resin, a polyvinylidene fluoride (PVDF) resin, an acrylonitrile butadiene styrene (ABS) resin, and chlorotrifluoroethylene (CTFE), or a mixture thereof.

25. The composition of claim 20, further comprising at least one selected from the group consisting of a hard coating agent, an ultraviolet (UV) blocking agent, or an infrared (IR) blocking agent.

26. A thermal insulation sheet having a visible light transmittance of 70% or more, a thermal conductivity of less than 0.1 W/m·K, and a filling rate of hollow silica particles of 30% to 80%, the thermal insulation sheet comprising:
a base material; and
a coating layer formed by coating the base material with the composition of claim 21.

27. The thermal insulation sheet of claim 26, wherein the coating layer has a UV and IR blocking function.

28. The thermal insulation sheet of claim 26, wherein the base material comprises a sheet of a polymer material, a textile, a film, or glass.

29. A method of manufacturing a thermal insulation sheet, the method comprising:
preparing a base material;
forming a coating layer by coating the base material with the composition of claim 20; and
curing the coating layer.
